(19) United States
(12) Patent Application Publication
(10) Pub. No.: US 2025/0382443 A1
(43) Pub. Date: Dec. 18, 2025

(54) Polyamide Composition having a Reduced Density

(71) Applicant: Ticona LLC, Florence, KY (US)

(72) Inventor: Ping Wang, Shanghai (CN)

(21) Appl. No.: 19/189,332

(22) Filed: Apr. 25, 2025

Related U.S. Application Data
(60) Provisional application No. 63/659,868, filed on Jun. 14, 2024.

(51) Int. Cl. C08K 7/14; C08G 69/26; C08K 5/17; C08K 7/28; C08K 9/06

(52) U.S. Cl. CPC C08K 7/14; C08K 5/17; C08K 7/28; C08K 9/06; C08G 69/26; C08K 2201/003; C08K 2201/016

(57) ABSTRACT

A polyamide composition that comprises a polymer matrix that includes a long-chain aliphatic polyamide and from about 50 to about 200 parts by weight of an inorganic filler distributed within the polymer matrix is provided. The inorganic filler includes inorganic fibers and hollow inorganic beads. The polyamide composition exhibits a density of about 1,000 kg/m³ or less as determined in accordance with ISO 1183:2019 and a tensile modulus of about 4,000 MP a or more as determined in accordance with ISO 527:2019 at a temperature of about 23° C.

### RELATED APPLICATION

The present application is based upon and claims priority to U.S. Provisional patent application Ser. No. 63/659,868, having a filing date of Jun. 14, 2024, which is incorporated herein by reference.

### BACKGROUND OF THE INVENTION

In an effort to reduce weight and minimize the carbon footprint of finished products, various attempts have been made to produce lower density polyamide compositions. A typical approach to producing such materials is by foaming the polyamide using physical or chemical blowing agents, which create gas cells though the bulk. For example, one method that has been employed involves incorporating a supercritical fluid (e.g., supercritical carbon dioxide) into the polyamide while it is in its melt state and under pressure. Unfortunately, typical foaming processes generate large cell sizes, which can lead to a poor surface appearance and also reduce melt strength, thus leading to breaks in high speed production processes with high deformation rates (e.g., injection molding). Attempts have also been made to use hollow microspheres in polyamide compositions. However, compositions made from such materials often have poor mechanical properties or require the use of costly additives (e.g., elastomeric impact modifiers and/or reactive polymeric compatibilizers) in an effort to achieve just a minimal degree of strength and flexibility. As such, a need currently exists for an improved technique for forming low density polyamide compositions.

### SUMMARY OF THE INVENTION

In accordance with one embodiment of the present invention, a polyamide composition is disclosed that comprises a polymer matrix that includes a long-chain aliphatic polyamide and from about 50 to about 200 parts by weight of an inorganic filler that is distributed within the polymer matrix. The inorganic filler includes inorganic fibers and hollow inorganic beads. The polyamide composition exhibits a density of about 1,000 kg/m³ or less as determined in accordance with ISO 1183:2019 and a tensile modulus of about 4,000 MP a or more as determined in accordance with ISO 527:2019 at a temperature of about 23° C.

Other features and aspects of the present invention are set forth in greater detail below.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polyamide composition that contains a polymer matrix including at least one long-chain aliphatic polyamide and an inorganic filler that is distributed within the polymer matrix that includes a combination of inorganic fibers and inorganic hollow beads. Through selective control over the nature of these and relative concentration of these components, the present inventors have discovered that the resulting polyamide composition may achieve a relatively low density and weight while still maintaining good mechanical properties. The density of the polyamide composition, for example, is typically about 1,000 kg/m³ or less, in some embodiments about 980 kg/m³ or less, in some embodiments about 970 kg/m³ or less, and in some embodiments, from about 600 to about 960 kg/m³, such as determined in accordance with ISO 1183:2019 (beginning dry). Despite having such a low density, the composition may exhibit a high degree of stiffness and ability to absorb heavy loads. This stiffness can be characterized by a high modulus, such as a tensile modulus of about 4,500 MP a or more, in some embodiments from about 5,000 MP a to about 20,000 MPa, and in some embodiments, from about 7,000 to about 15,000 MP a (ISO 527:2019 at a temperature of about 23° C.) and/or flexural modulus of 4,000 MP a or more, in some embodiments from about 5,000 MP a to about 20,000 MPa, and in some embodiments, from about 7,000 to about 15,000 MP a (ISO 178:2019 at a temperature of about 23° C.).

Of course, the polyamide composition may also exhibit other good mechanical properties. For example, the composition may, for example, exhibit a tensile strength of about 90 MP a or more, in some embodiments about 100 MP a or more, and in some embodiments, from about 110 to about 250 MPa and/or tensile elongation at break of from about 0.5% to about 10%, in some embodiments from about 0.8% to about 8%, and in some embodiments, from about 1% to about 5%, as determined in accordance with ISO 527:2019 at a temperature of about 23° C. The composition may also exhibit a flexural strength of about 60 MP a or more, in some embodiments about 100 MP a or more, and in some embodiments, from about 140 to about 250 MP a, as determined in accordance with ISO 178:2019 at a temperature of about 23° C. In addition, the polymer composition may also exhibit a Charpy notched impact strength of about 1 kJ/m² or more, in some embodiments from about 1.5 to about 20 kJ/m², and in some embodiments, from about 2 to about 10 kJ/m², as determined in accordance with ISO 179-1:2010 at a temperature of about 23° C. The polyamide composition may also be generally water resistant in that it exhibits a low degree of water absorption, such as about 1% or less, in some embodiments about 0.8% or less, and in some embodiments, from about 0.1 to about 0.6% after being immersed in water for 24 hours in accordance with ISO 62-1:2008 (beginning dry).

Various embodiments of the present invention will now be described in more detail.

### 1. Polyamide Composition

### A. Polymer Matrix

The polymer matrix typically constitutes from about 15 wt. % to about 70 wt. %, in some embodiments from about 20 wt. % to about 60 wt. %, and in some embodiments from about 25 wt. % to about 55 wt. %, and in some embodiments, from about 30 wt. % to about 50 wt. % of the polyamide composition. The polymer matrix contains at least one long-chain aliphatic polyamide. For example, such polyamides may constitute from about 50 wt. % to 100 wt. %, in some embodiments from about 70 wt. % to 100 wt. %, and in some embodiments, from about 90 wt. % to 100 wt. % of the polymer matrix (e.g., 100 wt. % such that long-chain aliphatic polyamides constitute the entire polymer matrix).

Aliphatic polyamides generally have a CO—NH linkage in the main chain and are obtained by condensation of an aliphatic diamine and an aliphatic dicarboxylic acid, by ring opening polymerization of lactam, or self-condensation of an aliphatic aminocarboxylic acid. Regardless of the specific monomer constituents, the polyamide is generally considered a “long-chain” polyamide in that at least one of the monomeric constituents (i.e., dicarboxylic acid and diamine, lactam, aminocarboxylic acid, etc.) has 7 or more carbon atoms, in some embodiments 8 or more carbon atoms, in some embodiments 9 or more carbon atoms, and in some embodiments, from 10 to 16 carbon atoms (e.g., 10 or 12). Desirably, each of the monomeric constituents has 6 or more carbon atoms. The ratio of carbon to nitrogen atoms in the resulting polyamide is also typically high, such as from about 6 to about 15, in some embodiments from about 7 to about 14, and in some embodiments, from about 8 to about 12 (e.g., 8 or 9).

In one particular embodiment, for example, the long-chain polyamide is formed from an aliphatic diamine and an aliphatic dicarboxylic acid. The aliphatic diamine typically has from 6 to 40 carbon atoms, in some embodiments from 7 to 30 carbon atoms, in some embodiments from 8 to 24 carbon atoms, in some embodiments from 9 to 22 carbon atoms, and in some embodiments, from 10 to 20 carbon atoms. Examples of such diamines may include, for instance, linear aliphatic alkylenediamines, such as 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Suitable aliphatic dicarboxylic acids may include those having from 6 to 40 carbon atoms, in some embodiments from 7 to 30 carbon atoms, in some embodiments from 8 to 24 carbon atoms, in some embodiments from 9 to 22 carbon atoms, and in some embodiments, from 10 to 20 carbon atoms. Examples of such aliphatic dicarboxylic acids may include, for instance, adipic acid, pimelic acid, suberic acid, azelaic acid, sebacic acid, undecanedioic acid, dodecanedioic acid, tridecanedioic acid, tetradecanedioic acid, pentadecanedioic acid, hexadecanedioic acid, octadecanedioic acid, eicosanedioic acid, etc., as well as combinations thereof. The resulting long chain aliphatic polyamide may, for example, be PA68, PA610, PA612, PA614, PA618, PA88, PA810, PA812, PA1010, PA1012, PA1014, PA1018, PA1210, PA1212, PA1214, PA1218, PA1313, PA1410, PA1412, PA 1414, PA1418, etc., as well as combinations thereof. In one particular embodiment, for example, PA612 and/or PA610 may be employed.

The long-chain aliphatic polyamide(s) employed in the polyamide composition are generally semi-crystalline in nature and thus have a measurable melting temperature. The melting temperature is typically from about 180° C. to about 260° C., in some embodiments from about 190° C. to about 250° C., and in some embodiments, from about 200° C. to about 240° C., such as determined using differential scanning calorimetry (“DSC”), such as determined by 11357-3:2018. The long-chain aliphatic polyamide(s) also typically have a low degree of water absorption, such as about 1% or less, in some embodiments about 0.8% or less, and in some embodiments, from about 0.1 to about 0.6% after being immersed in water for 24 hours in accordance with ISO 62-1:2008 (beginning dry). The density of the long-chain aliphatic polyamide(s) is also typically from about 960 to about 1,500 kg/m³, in some embodiments from about 980 to about 1,400 kg/m³, and in some embodiments, from about 1,000 to about 1,200 kg/m³, such as determined in accordance with ISO 1183:2019 (beginning dry).

If desired, the long-chain polyamide(s) may also be blended with other types of polyamides, such as other aliphatic polyamides, semi-aromatic polyamides, wholly aromatic polyamides, etc. When employed, such other polyamide(s) typically constitute from 0.01 wt. % to about 50 wt. %, in some embodiments from 0.1 wt. % to about 30 wt. %, and in some embodiments, from 0.5 wt. % to about 10 wt. % of the polymer matrix. Other suitable aliphatic polyamides may include, for instance, PA4 (poly-α-pyrrolidone), PA6 (polycaproamide), PA11 (polyundecanamide), PA12 (polydodecanamide), PA46 (polytetramethylene adipamide), PA66 (polyhexamethylene adipamide), etc. PA6 and/or PA66 are particularly suitable. When polyamide(s) are employed that contain aromatic monomer units, they are generally considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene terephthalamide/dodecamethylene dodecanediamide) (PA12T/1212), poly(dodecamethylene terephthalamide/caprolactam) (PA12T/6), poly(dodecamethylene terephthalamide/hexamethylene hexanediamide) (PA12T/66), and so forth.

### B. Inorganic Filler

As noted above, the polyamide composition also contains an inorganic filler distributed within the polymer matrix. The inorganic filler is generally present in the composition in an amount of from about 50 to about 200 parts, in some embodiments from about 70 to about 180 parts, and in some embodiments, from about 80 to about 160 parts by weight per 100 parts by weight of the polymer matrix. For example, the inorganic filler may constitute from about 40 wt. % to about 80 wt. %, in some embodiments from about 45 wt. % to about 75 wt. %, and in some embodiments, from about 50 wt. % to about 70 wt. % of the entire polyamide composition. In certain embodiments, the inorganic filler is present in an amount (by weight) greater than the polymer matrix such that the inorganic filler is present in an amount greater than 100 parts by weight of the polymer matrix.

The inorganic filler generally includes a specifically tailored combination of both inorganic fibers and a hollow inorganic beads. For example, the weight ratio of the inorganic fibers to the hollow inorganic beads is typically from about 1 to about 5, in some embodiments from about 1.1 to about 4, in some embodiments from about 1.1 to about 2.5, and in some embodiments, from about 1.2 to about 2. The inorganic fibers may, for instance, constitute from 20 to about 80 parts, in some embodiments from about 25 to about 75 parts, and in some embodiments, from about 30 to about 50 parts by weight per 100 parts by weight of the polymer matrix, and the hollow inorganic beads may constitute from about 30 to about 90 parts, in some embodiments from about 40 to about 80 parts, and in some embodiments, from about 50 to about 70 parts by weight per 100 parts by weight of the polymer matrix. For example, the inorganic fibers may constitute from about 5 wt. % to about 40 wt. %, in some embodiments from about 10 wt. % to about 35 wt. %, and in some embodiments, from about 15 wt. % to about 30 wt. % of the entire polyamide composition, and the hollow inorganic beads may constitute from about 10 wt. % to about 50 wt. %, in some embodiments from about 20 wt. % to about 40 wt. %, and in some embodiments, from about 25 wt. % to about 35 wt. % of the entire polyamide composition.

The inorganic fibers typically have a high degree of tensile strength relative to their mass. For example, the ultimate tensile strength of the fibers (determined in accordance with ASTM D3822/D822 M-14 (2020)) is typically from about 1,000 to about 15,000 Megapascals (“MPa”), in some embodiments from about 2,000 MP a to about 10,000 MP a, and in some embodiments, from about 3,000 MP a to about 6,000 MP a. In certain cases, it may also be desirable to employ fibers having a high degree of temperature resistance as characterized by a high softening point, such as about 850° C. or more, in some embodiments from about 900° C. or more, and in some embodiments, from about 910° C. to about 980° C., as determined in accordance with ASTM C338-93 (2019). The inorganic fibers may be formed from materials that are generally insulative in nature, such as glass, ceramics (e.g., alumina or silica), etc. Glass fibers are particularly suitable, such as E-glass, A-glass, C-glass, D-glass, AR-glass, R-glass, S1-glass, S2-glass, etc. Although the fibers may have a variety of different sizes, fibers having a certain size can help improve the mechanical properties of the resulting polyamide composition. The inorganic fibers may, for example, have an average diameter of about 5 micrometers or more, in some embodiments about 6 micrometers or more, in some embodiments from about 8 micrometers to about 40 micrometers, and in some embodiments from about 9 micrometers to about 20 micrometers, such as determined in accordance with ISO 1888:2022. The fibers may also have a volume average length (before compounding) of about 0.5 millimeters or more, in some embodiments about 1 millimeter or more, and in some embodiments, from about 2 micrometers to about 6 millimeters.

The hollow inorganic beads typically have an interior hollow space or cavity and may be formed from an insulative material such as described above. Although by no means required, it may be desired in certain cases that the same material (e.g., glass) is used to form both the inorganic fibers and hollow inorganic beads. In one embodiment, for example, hollow glass beads may be made from a soda-lime borosilicate glass, soda lime glass, borosilicate glass, sodium borosilicate glass, sodium silicate glass, aluminosilicate glass, etc., as well as combinations thereof. Soda-lime borosilicate glass may be particularly suitable due to its high degree of water resistance. For example, the glass may contain at least about 65% by weight of SiO₂, 3-15% by weight of Na₂O, 8-15% by weight of CaO, 0.1-5% by weight of MgO, 0.01-3% by weight of Al₂O₃, 0.01-1% by weight of K₂O, and optionally other oxides (e.g., Li₂O, Fe₂O₃, TiO₂, B₂O₃). In another embodiment, the composition may contain about 50-58% by weight of SiO₂, 25-30% by weight of Al₂O₃, 6-10% by weight of CaO, 1-4% by weight of Na₂O/K₂O, and 1-5% by weight of other oxides. Also, in one embodiment, the hollow glass fillers may include more alkaline earth metal oxides than alkali metal oxides. For example, the weight ratio of the alkaline earth metal oxides to the alkali metal oxides may be more than 1, in some embodiments about 1.1 or more, in some embodiments about 1.2 to about 4, and in some embodiments from about 1.5 to about 3. Techniques for preparing the hollow inorganic beads are known in the art and typically include heating milled inorganic frit in the presence of a blowing agent (e.g., sulfur or compound of oxygen and sulfur) at high temperatures.

The hollow inorganic beads typically have an average diameter (by volume) of from about 1 to about 50 micrometers, in some embodiments from about 5 to about 40 micrometers, and in some embodiments, from about 10 to about 30 micrometers. The particle size may, for example, be determined using laser light diffraction, such as by dispersing the beads in deaerated, deionized water (e.g., in accordance with 3 M QCM 193.0). The hollow inorganic beads may have an average aspect ratio of about 0.8 or more, in some embodiments about 0.85 or more, in some embodiments from about 0.9 to about 1.3, and in some embodiments from about 0.95 to about 1.05 (i.e., spherical). The hollow inorganic beads also typically have an average true density of about 0.2 g/cm³ or more, in some embodiments from about 0.2 g/cm³ to about 0.8 g/cm³, in some embodiments from about 0.3 g/cm³ or more to about 0.7 g/cm³, and in some embodiments, from about 0.35 g/cm³ to about 0.6 g/cm³. The “average true density” is the quotient obtained by dividing the mass of a sample of hollow beads by the true volume of that mass of beads. The “true volume” is the aggregate total volume of the hollow beads as opposed to the bulk volume. The true density may be determined using a gas pycnometer (e.g., in accordance with 3 M QCM 14.24.1). Even though the beads are hollow, it is typically desired that they exhibit a certain crush strength, which can be characterized by the hydrostatic pressure at which 10% by volume of the hollow beads collapse (e.g., in accordance to 3 M QCM 14.1.8). The crush strength may, for example, be about 10 MP a or more, in some embodiments from about 40 to about 250 MPa, and in some embodiments from about 80 MP a to about 200 MP a.

While not required, the hollow inorganic beads may, in certain embodiments, be formed to include amino groups on at least a portion of their surfaces by treating the beads with an amino-functional coupling agent (e.g., silanes, zirconates, titantates, etc.). Suitable amino-functional silanes, for example, be represented by formula Z₂N-L-SiYₓY′₃₋ₓ, wherein each Z is independently hydrogen, alkyl having up to 12 carbon atoms, or -L-SiYₓY′₃₋ₓ, wherein L is a multivalent alkylene group having up to 12 carbon atoms and optionally interrupted by one or more —O— groups or up to three —NR— groups, wherein R is hydrogen or alkyl; Y is a hydrolysable group (e.g., alkoxy having up to 12 carbon atoms, polyalkyleneoxy having up to 12 carbon atoms, or halogen), x is 1, 2, or 3, and Y′ is a non-hydrolysable group (e.g., alkyl having up to 12 carbon atoms). Examples of such amino-functional silanes include 3-aminopropyltrimethoxysilane; 3-aminopropyltriethoxysilane; 3-aminopropyltris(methoxyethoxyethoxy) silane; 3-aminopropylmethyldiethoxysilane; 3-aminopropylmethyldimethoxysilane; 3-aminopropyldimethylmethoxysilane; 3-aminopropyldimethylethoxysilane; 4-aminobutyltrimethoxysilane; 4-aminobutyltriethoxysilane; N-(2-aminoethyl)-3-aminopropylmethyldimethoxysilane; N-(2-aminoethyl)-3-aminopropyltributoxysilane; N-(2-aminoethyl)-3-aminopropylmethyldiethoxysilane; N-(2-aminoethyl)-3-aminopropyltrimethoxysilane; N-(2-aminoethyl)-3-aminopropyltriethoxysilane; N-(6-aminohexyl)aminopropyltrimethoxysilane; bis-(gamma-triethoxysilylpropyl)amine; bis(3-trimethoxysilylpropyl)amine; and 3-(N-methylamino) propyltrimethoxysilane. Without intending to be limited by theory, it is believed that the resulting amino functional groups can help improve the compatibility of the hollow beads with the polyamide(s) in the polymer matrix.

### C. Other Components

A wide variety of additional additives can also be included in the polyamide composition, such as flame retardants, stabilizers, nucleating agents, lubricants, pigments, colorants, slip additives, and/or other materials added to enhance properties and processability.

In one embodiment, for example, the polyamide composition may contain a stabilizer system that includes one or more heat stabilizers (e.g., copper compounds), light stabilizers (e.g., hindered amine stabilizers), antioxidants (e.g., sterically hindered phenolic antioxidant, phosphorous-based antioxidant, etc.), as well as combinations thereof. For example, the polyamide composition may contain one or more sterically hindered phenolic antioxidants, such as in an amount of from about 0.01 wt. % to about 1 wt. %, in some embodiments from about 0.05 wt. % to about 0.8 wt. %, and in some embodiments, from about 0.1 wt. % to about 0.5 wt. % of the entire polyamide composition. Suitable sterically-hindered phenolic antioxidants may include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl) hydrazide (Irganox® 1024); 4,4′-di-tert-octyldiphenamine (Naugalube® 438R); phosphonic acid, (3,5-di-tert-butyl-4-hydroxybenzyl)-, dioctadecyl ester (Irganox® 1093); 1,3,5-trimethyl-2,4,6-tris(3′,5′-di-tert-butyl-4′hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tertbutylphenol) monoacrylate (Irganox® 3052); 2-tert-butyl-6-[1-(3-tert-butyl-2-hydroxy-5-methylphenyl)ethyl]-4-methylphenyl acrylate (Sumilizer® ™ 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole; 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl(3,5-di-tert-butyl-4-hydroxybenzyl)phosphonate (Irganox® 1222); 4,4′-di-tert-octyldiphenylamine (Irganox® 5057); N-phenyl-1-naphthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate; 3,9-bis[1,1-dimethyl-2-[(3-tert-butyl-4-hydroxy-5-methylphenyl)propionyloxylethyl]-2,4,8,10-tetraoxaspiro[5.5]undecane; tetrakis[methylene-(3,5-di-tertbutyl-4-hydroxycinnamate)]methane (Irganox® 1010); and ethylene-bis(oxyethylene) bis[3-(5-tert-butyl-4-hydroxy-m-tolyl)-propionate (Irganox® 245); and so forth.

The stabilizer system may also include one or more hindered amine light stabilizers, such as in an amount of from about 0.001 wt. % to about 1 wt. %, in some embodiments from about 0.01 wt. % to about 0.5 wt. %, and in some embodiments, from about 0.05 wt. % to about 0.3 wt. % of the entire polyamide composition. Suitable hindered amine light stabilizers may include, for example, contain one or more compounds of the following general structures:

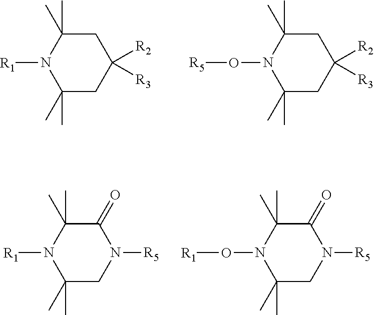

wherein,
R₁, R₂, R₃, and R₅ are independently hydrogen, ether groups, ester groups, amine groups, amide groups, alkyl groups, alkenyl groups, alkynyl groups, aralkyl groups, cycloalkyl groups and aryl groups, in which the substituents in turn may contain functional groups; examples of functional groups are alcohols, ketones, anhydrides, imines, siloxanes, ethers, carboxyl groups, aldehydes, esters, amides, imides, amines, nitriles, ethers, urethanes, or any combination thereof.

The hindered amine light stabilizer may include a substituted piperidine compound, such as an alkyl-substituted piperidyl, piperidinyl or piperazinone compound, and substituted alkoxypiperidinyl compounds. Examples of such compounds may include, for instance, N,N′-bis(2,2,6,6-tetramethyl-4-piperidyl)-1,3-benzenedicarboxamide (Nylostab® S-EED); 2,2,6,6-tetramethyl-4-piperidone; 2,2,6,6-tetramethyl-4-piperidinol; bis-(1,2,2,6,6-pentamethyl piperidyl)-(3′,5′-di-tert-butyl-4′-hydroxybenzyl)butylmalonate; di-(2,2,6,6-tetramethyl-4-piperidyl) sebacate (Tinuvin® 770); oligomer of N-(2-hydroxyethyl)-2,2,6,6-tetramethyl-4-piperidinol and succinic acid (Tinuvin® 622); oligomer of cyanuric acid and N, N-di(2,2,6,6-tetramethyl-4-piperidyl)-hexamethylene diamine; bis-(2,2,6,6-tetramethyl-4-piperidinyl) succinate; bis-(1-octyloxy-2,2,6,6-tetramethyl-4-piperidinyl) sebacate (Tinuvin® 123); bis-(1,2,2,6,6-pentamethyl-4-piperidinyl) sebacate (Tinuvin® 765); tetrakis-(2,2,6,6-tetramethyl-4-piperidyl)-1,2,3,4-butane tetracarboxylate; N,N′-bis-(2,2,6,6-tetramethyl-4-piperidyl)-hexane-1,6-diamine (Chimasorb® T5); N-butyl-2,2,6,6-tetramethyl-4-piperidinamine; 2,2′-[(2,2,6,6-tetramethyl-piperidinyl)-imino]-bis-[ethanol]; poly((6-morpholine-5-triazine-2,4-diyl) (2,2,6,6-tetramethyl-4-piperidinyl)-iminohexarethylene-(2,2,6,6-tetramethyl-4-piperidinyl)-imino) (Cyasorb® UV 3346); 5-(2,2,6,6-tetramethyl-4-piperidinyl)-2-cyclo-undecyl-oxazole) (Hostavin® N20); 1,1′-(1,2-ethane-di-yl)-bis-(3,3′,5,5′-tetramethyl-piperazinone); polymethylpropyl-3-oxy-[4 (2,2,6,6-tetramethyl)-piperidinyl]siloxane (Uvasil® 299); 1,2,3,4-butane-tetracarboxylic acid-1,2,3-tris(1,2,2,6,6-pentamethyl-4-piperidinyl)-4-tridecylester; copolymer of alpha-methylstyrene-N-(2,2,6,6-tetramethyl-4-piperidinyl) maleimide and N-stearyl maleimide; D-glucitol, 1,3:2,4-bis-O-(2,2,6,6-tetramethyl-4-piperidinylidene)-(HALS 7); oligomer of 7-oxa-3,20-diazadispiro[5.1.11.2]-heneicosen-21-one-2,2,4,4-tetramethyl-I-20-(oxiranylmethyl) (Hostavin® N30); propanedioic acid, [(4-methoxyphenyl)methylene]-, bis(1,2,2,6,6-pentamethyl-4-piperidinyl) ester (Sanduvor® PR 31); formamide, N,N′-1,6-hexanediylbis[N-(2,2,6,6-tetramethyl-4-piperidinyl (Uvinul® 4050H); 1,3,5-triazine-2,4,6-triarine, N,N″-[1,2-ethanediylbis[[4,6-bis[butyl(1,2,2,6,6-pentamethyl-4-piperidinyl)amino]-1,3,5-triazine-2-yl]imino]-3,1-propanediyl]]-bis[N′,N″-dibutyl-I-N′,N″-bis(1,2,2,6,6-pentamethyl-4-piperidinyl) (Chimassorb® 119 MW 2286); poly[6-[(1,1,3,33-tetramethylbutyl)amino]-1,3,5-triazine-2,4-diyl][(2,2,6,6-tetramethyl-4-piperidinyl)-imino]-1,6-hexanediyl[(2,2,6,6-tetramethyl-4-piperidinyl)imino]] (Chimassorb® 944 MW 2000-3000); 1,5-dioxaspiro(5,5) undecane 3,3-dicarboxylic acid, bis(2,2,6,6-tetramethyl-4-piperidinyl) ester (Cyasorb® UV-500); 1,5-dioxaspiro(5,5) undecane 3,3-dicarboxylic acid, bis(1,2,2,6,6-pentamethyl-4-piperidinyl) ester (Cyasorb® UV-516); N-2,2,6,6-tetramethyl-4-piperidinyl-N-amino-oxamide; 4-acryloyloxy-1,2,2,6,6-pentamethyl-4-piperidine; 1,5,8,12-tetrakis[2′,4′-bis(1″,2″,2″,6″,6″-pentamethyl-4″-piperidin-yl(butyl)amino)-1′,3′,5′-triazine-6′-yl]-1,5,8,12-tetraazadodecane; 3-dodecyl-1-(2,2,6,6-tetramethyl-4-piperidyl)-pyrrolidin-2,5-dione; 1,1′-(1,2-ethane-di-yl)-bis-(3,3′,5,5′-tetra-methyl-piperazinone) (Goodrite® 3034); 1,1,′1″-(1,3,5-triazine-2,4,6-triyltris((cyclohexylamino)-2,1-ethanediyl)tris(3,3,5,5-tetramethylpiperazinone) (Goodrite® 3150); 1,1′,1″-(1,3,5-triazine-2,4,6-triyltris((cyclohexylamino)-2,1-ethanediyl)tris(3,3,4,5,5-tetramethylpiperazinone) (Goodrite® 3159); and so forth.

Copper-based heat stabilizers may also be employed in the stabilizer system, such as in an amount from about 0.01 wt. % to about 5 wt. %, in some embodiments from about 0.1 wt. % to about 1.5 wt. %, and in some embodiments, from about 0.3 wt. % to about 0.8 wt. % of the entire polyamide composition. When employed, the copper compound generally includes a copper (I) salt, copper (II) salt, copper complex, or a combination thereof. For example, the copper (I) salt may be CuI, CuBr, CuCl, CuCN, CU2O, or a combination thereof and/or the copper (II) salt may be copper acetate, copper stearate, copper sulfate, copper propionate, copper butyrate, copper lactate, copper benzoate, copper nitrate, CuO, CuCl2, or a combination thereof. In certain embodiments, the copper compound may be a copper complex that contains an organic ligand, such as alkyl phosphines, such as trialkylphosphines (e.g., tris-(n-butyl)phosphine) and/or dialkylphosphines (e.g., 2-bis-(dimethylphosphino)-ethane); aromatic phosphines, such as triarylphosphines (e.g., triphenylphosphine or substituted triphenylphosphine) and/or diarylphosphines (e.g., 1,6-(bis-(diphenylphosphino))-hexane, 1,5-bis-(diphenylphosphino)-pentane, bis-(diphenylphosphino) methane, 1,2-bis-(diphenylphosphino) ethane, 1,3-bis-(diphenylphosphino)propane, 1,4-bis-(diphenylphosphino) butane, etc.); mercaptobenzimidazoles; glycines; oxalates; pyridines (e.g., bypyridines); amines (e.g., ethylenediaminetetraacetates, diethylenetriamines, triethylenetetramines, etc.); acetylacetonates; and so forth, as well as combinations of the foregoing. Particularly suitable copper complexes for use in the heat stabilizer may include, for instance, copper acetylacetonate, copper oxalate, copper EDTA, [Cu(PPh3)3X], [Cu2X(PPH3)3], [Cu(PPh3)X], [Cu(PPh3)2X], [CuX(PPh3)-2,2′-bypyridine], [CuX(PPh3)-2,2′-biquinoline)], or a combination thereof, wherein PPh3 is triphenylphosphine and X is CI, Br, I, CN, SCN, or 2-mercaptobenzimidazole. Other suitable complexes may likewise include 1,10-phenanthroline, o-phenylenebis(dimethylarsine), 1,2-bis(diphenylphosphino)-ethane, terpyridyl, and so forth.

The copper complexes may be formed by reaction of copper ions (e.g., copper (I) ions) with the organic ligand compound (e.g., triphenylphosphine or mercaptobenzimidazole compounds). For example, these complexes can be obtained by reacting triphenylphosphine with a copper (I) halide suspended in chloroform (G. Kosta, E. Reisenhofer and L. Stafani, J. Inorg. Nukl. Chem. 27 (1965) 2581). However, it is also possible to reductively react copper (II) compounds with triphenylphosphine to obtain the copper (I) addition compounds (F. U. Jardine, L. Rule, A. G. Vohrei, J. Chem. Soc. (A) 238-241 (1970)). However, the complexes used according to the invention can also be produced by any other suitable process. Suitable copper compounds for the preparation of these complexes are the copper (I) or copper (II) salts of the hydrogen halide acids, the hydrocyanic acid or the copper salts of the aliphatic carboxylic acids. Examples of suitable copper salts are copper (I) chloride, copper (I) bromide, copper (I) iodide, copper (I) cyanide, copper (II) chloride, copper (II) acetate, copper (II) stearate, etc., as well as combinations thereof. Copper (I) iodide and copper (I) cyanide are particularly suitable.

In addition to a copper compound, the heat stabilizer may also contain a halogen-containing synergist. When employed, the copper compound and halogen-containing synergist are typically used in quantities to provide a copper:halogen molar ratio of from about 1:1 to about 1:50, in some embodiments from about 1:4 to about 1:20, and in some embodiments, from about 1:6 to about 1:15. For example, the halogen content of the polyamide composition may be from about 10 ppm to about 10,000 ppm, in some embodiments from about 50 ppm to about 5,000 ppm, in some embodiments from about 100 ppm to about 2,000 ppm, and in some embodiments, from about 300 ppm to about 1,500 ppm. The halogenated synergist generally includes an organic halogen-containing compound, such as aromatic and/or aliphatic halogen-containing phosphates, aromatic and/or aliphatic halogen-containing hydrocarbons; and so forth, as well as combinations thereof. For example, suitable halogen-containing aliphatic phosphates may include tris(halohydrocarbyl)-phosphates and/or phosphonate esters. Tris(bromohydrocarbyl)phosphates (brominated aliphatic phosphates) are particularly suitable. In particular, in these compounds, no hydrogen atoms are attached to an alkyl C atom which is in the alpha position to a C atom attached to a halogen. This minimizes the extent that a dehydrohalogenation reaction can occur which further enhances stability of the polyamide composition. Specific exemplary compounds are tris(3-bromo-2,2-bis(bromomethyl)propyl)phosphate, tris(dibromoneopentyl)phosphate, tris(trichloroneopentyl)phosphate, tris(bromodichlorneopentyl)phosphate, tris(chlordibromoneopentyl)phosphate, tris(tribromoneopentyl)phosphate, or a combination thereof. Suitable halogen-containing aromatic hydrocarbons may include halogenated aromatic polymers (including oligomers), such as brominated styrene polymers (e.g., polydibromostyrene, polytribromostyrene, etc.); halogenated aromatic monomers, such as brominated phenols (e.g., tetrabromobisphenol-A); and so forth, as well as combinations thereof.

If desired, the polyamide composition may also include one or more lubricants, such as in an amount from about 0.01 wt. % to about 5 wt. %, in some embodiments from about 0.1 wt. % to about 3 wt. %, and in some embodiments, from about 0.2 wt. % to about 1 wt. % of the polyamide composition. When employed, the weight ratio of the stabilizer system to the lubricant(s) may be selectively controlled to achieve the desired properties, such as within a range of from about 0.5 to about 10, in some embodiments from about 0.8 to about 5, and in some embodiments, from about 1 to about 4. The lubricant may be derived from a fatty acid and has an acid value of about 6 to about 18 mg KOH/g, in some embodiments about 8 to about 16 mg KOH/g, and in some embodiments, from about 10 to about 14 mg KOH/g as determined in accordance with ISO 2114:2000. For example, the lubricant may be formed from a fatty acid salt derived from fatty acids having a chain length of from 22 to 38 carbon atoms, and in some embodiments, from 24 to 36 carbon atoms. Examples of such fatty acids may include long chain aliphatic fatty acids, such as montanic acid (octacosanoic acid), arachidic acid (arachic acid, icosanoic acid, icosanoic acid, n-icosanoic acid), tetracosanoic acid (lignoceric acid), behenic acid (docosanoic acid), hexacosanoic acid (cresotinic acid), melissic acid (triacontanoic acid), erucic acid, cetoleic acid, brassidic acid, selacholeic acid, nervonic acid, etc. For example, montanic acid has an aliphatic carbon chain of 28 atoms and arachidic acid has an aliphatic carbon chain of 20 atoms. Due to the long carbon chain provided by the fatty acid, the lubricant has a high thermostability and low volatility. This allows the lubricant to remain functional during formation of the desired article to reduce internal and external friction, thereby reducing the degradation of the material caused by mechanical/chemical effects.

The fatty acid salt may be formed by saponification of a fatty acid wax to neutralize excess carboxylic acids and form a metal salt. Saponification may occur with a metal hydroxide, such as an alkali metal hydroxide (e.g., sodium hydroxide) or alkaline earth metal hydroxide (e.g., calcium hydroxide). The resulting fatty acid salts typically include an alkali metal (e.g., sodium, potassium, lithium, etc.) or alkaline earth metal (e.g., calcium, magnesium, etc.). Particularly suitable fatty acid salts are derived from crude montan wax, which contains straight-chain, unbranched monocarboxylic acids with a chain length in the range of C28-C32. Such montanic acid salts are commercially available from Clariant GmbH under the designations Licomont® CaV 102 (calcium salt of long-chain, linear montanic acids) and Licomont® NaV 101 (sodium salt of long-chain, linear montanic acids).

If desired, fatty acid esters may be used in combination with the fatty acid salts. When employed, the molar ratio of the salts to esters is typically about 1:1 or greater, in some embodiments about 1.5 or greater, and in some embodiments, about 2:1 or greater. Fatty acid esters may be obtained by oxidative bleaching of a crude natural wax and subsequent esterification of the fatty acids with an alcohol. The alcohol typically has 1 to 4 hydroxyl groups and 2 to 20 carbon atoms. When the alcohol is multifunctional (e.g., 2 to 4 hydroxyl groups), a carbon atom number of 2 to 8 is particularly desired. Particularly suitable multifunctional alcohols may include dihydric alcohol (e.g., ethylene glycol, propylene glycol, butylene glycol, 1,3-propanediol, 1,4-butanediol, 1,6-hexanediol and 1,4-cyclohexanediol), trihydric alcohol (e.g., glycerol and trimethylolpropane), tetrahydric alcohols (e.g., pentaerythritol and erythritol), and so forth. Aromatic alcohols may also be suitable, such as o-, m- and p-tolylcarbinol, chlorobenzyl alcohol, bromobenzyl alcohol, 2,4-dimethylbenzyl alcohol, 3,5-dimethylbenzyl alcohol, 2,3,5-cumobenzyl alcohol, 3,4,5-trimethylbenzyl alcohol, p-cuminyl alcohol, 1,2-phthalyl alcohol, 1,3-bis(hydroxymethyl)benzene, 1,4-bis(hydroxymethyl)benzene, pseudocumenyl glycol, mesitylene glycol and mesitylene glycerol. Particularly suitable fatty acid esters for use in the present invention are derived from montanic waxes. Licowax® OP (Clariant), for instance, contains montanic acids partially esterified with butylene glycol and montanic acids partially saponified with calcium hydroxide. Thus, Licowax® OP contains a mixture of montanic acid esters and calcium montanate. Other montanic acid esters that may be employed include Licowax® E and Licolub® WE 4 (all from Clariant), for instance, are montanic esters obtained as secondary products from the oxidative refining of raw montan wax. Licowax® E and Licolub® WE 4 contain montanic acids esterified with ethylene glycol or glycerine.

While various additional additives, such as described above, may be employed in the polyamide composition, one beneficial aspect of the present invention is that good properties may be provided without the need for certain types of conventional costly additives, such as blowing agents (e.g., chlorofluorocarbons, hydrochlorofluorocarbons, hydrocarbons, carbon dioxide, supercritical carbon dioxide, nitrogen, etc.); elastomeric impact modifiers (e.g., ethylene-acrylate ester copolymers, ethylene-propylene copolymer rubbers, ethylene-propylene-diene terpolymer rubbers, styrene-butadiene rubbers, hydrogenated styrene-butadiene copolymers, etc.); or reactive polymeric compatibilizers (e.g., polyolefins with a grafted anhydride (e.g., maleic anhydride) or epoxy functional group). In typical embodiments, for instance, the polyamide composition is generally free of such components. For example, if employed at all, such blowing agents, elastomeric impact modifiers, and reactive polymeric compatibilizers are each typically present in an amount of no more than about 1 wt. %, in some embodiments no more than about 0.5 wt. %, and in some embodiments, from about 0.001 wt. % to about 0.2 wt. % of the polyamide composition.

### II. Melt Processing

The polyamide, inorganic filler, and other optional additives may be melt processed or blended together. The components may be supplied separately or in combination to an extruder that includes at least one screw rotatably mounted and received within a barrel (e.g., cylindrical barrel) and may define a feed section and a melting section located downstream from the feed section along the length of the screw. The inorganic filler (e.g., fibers and/or hollow beads) may optionally be added a location downstream from the point at which the polyamide is supplied (e.g., hopper). One or more of the sections of the extruder are typically heated, such as within a temperature range of from about 180° C. to about 350° C., in some embodiments, from about 190° C. to about 300° C., and in some embodiments, from about 200° C. to about 280° C. to form the composition. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds-1, in some embodiments from about 500 seconds⁻¹ to about 5000 seconds-1, and in some embodiments, from about 800 seconds⁻¹ to about 1200 seconds-1. The apparent shear rate is equal to 4Q/πR³, where Q is the volumetric flow rate (“m³/s”) of the polymer melt and R is the radius (“m”) of the capillary (e.g., extruder die) through which the melted polymer flows.

Regardless of the particular manner in which it is formed, the resulting polyamide composition can possess excellent thermal properties. For example, the melt viscosity of the polyamide composition may be low enough so that it can readily flow into the cavity of a mold having small dimensions. In one particular embodiment, the polyamide composition may have a melt volume flow rate (“MVR”) of about 500 cm³/10 in or less, in some embodiments about 250 cm³/10 min or less, and in some embodiments, from about 40 to about 150 cm³/10 min, as determined at a temperature of 275° C. and load of 5 kilograms in accordance with ISO 1133:2011.

### III. Formed Component

A variety of different components may be formed from the polyamide composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polyamide composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polyamide composition into the desired article also occurs within a mold. The composition may be placed into the compression mold using any known technique, such as by being picked up by an automated robot arm. The temperature of the mold may be maintained at or above the solidification temperature of the polyamide composition for a desired time period to allow for solidification. The molded product may then be solidified by bringing it to a temperature below that of the melting temperature. The resulting product may be de-molded. The cycle time for each molding process may be adjusted to suit the polyamide composition, to achieve sufficient bonding, and to enhance overall process productivity.

### IV. Product Applications

Due to its unique combination of properties (e.g., lightweight and good mechanical properties), the polyamide composition and components formed therefrom may be employed in a wide variety of potential product applications. For example, the polyamide composition is well suited for use in an electronic component. In one particular embodiment, the polyamide composition and molded components formed therefrom may be employed in a portable electronic device, such as in or as its housing. Examples of such devices may include, for instance, cellular telephones, portable computers (e.g., laptop computers, netbook computers, tablet computers, etc.), wrist-watch devices, headphone and earpiece devices, media players with wireless communications capabilities, handheld computers (also sometimes called personal digital assistants), remote controllers, global positioning system (GPS) devices, handheld gaming devices, camera modules, integrated circuits (e.g., SIM cards), etc. Wireless portable electronic devices are particularly suitable. Examples of such devices may include a laptop computer or small portable computer of the type that is sometimes referred to as “ultraportables.” In one suitable arrangement, the portable electronic device may be a handheld electronic device. The device may also be a hybrid device that combines the functionality of multiple conventional devices. Examples of hybrid devices include a cellular telephone that includes media player functionality, a gaming device that includes a wireless communications capability, a cellular telephone that includes game and email functions, and a handheld device that receives email, supports mobile telephone calls, has music player functionality and supports web browsing.

The present invention may be better understood with reference to the following examples.

### Test Methods

Tensile Modulus, Tensile Stress, and Tensile Elongation at Break: Tensile properties may be tested according to ISO 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation at Break: Flexural properties may be tested according to ISO Test No. 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C. For “notched” impact strength, this test may be run using a Type A notch (0.25 mm base radius) and Type 1 specimen size (length of 80 mm, width of 10 mm, and thickness of 4 mm).

### Comparative Example 1

A commercially sample (Comparative Example 1) is formed that contains 57.1 wt. % poly(hexamethylene sebacamide (PA610, melting point of 220° C., humidity absorption of 1.4% according to ISO 62, water absorption of 3.3% after being immersed in water for 24 hours), 22 wt. % hollow glass beads (crush strength of about 110 MP a, true density of about 0.46, average diameter of about 20 micrometers), 12 wt. % of an ethylene-octene elastomeric impact modifier, 8 wt. % of a maleic anhydride modifier polyolefin compatibilizer, 0.4 wt. % of an oligomeric hindered light amine stabilizer, 0.2 wt. % of sterically hindered phenolic antioxidant, and 0.3 wt. % of a lubricant (calcium salt of long chain, saturated, linear montanic acids).

### Comparative Example 2

A commercially sample (Comparative Example 2) is formed that contains 76.1 wt. % poly(hexamethylene sebacamide (PA610, melting point of 220° C., humidity absorption of 1.4% according to ISO 62, water absorption of 3.3% after being immersed in water for 24 hours), 17 wt. % hollow glass beads (crush strength of about 110 MP a, true density of about 0.46, average diameter of about 20 micrometers), 6 wt. % glass fibers, 0.4 wt. % of an oligomeric hindered light amine stabilizer, 0.2 wt. % of sterically hindered phenolic antioxidant, and 0.3 wt. % of a lubricant (calcium salt of long chain, saturated, linear montanic acids).

### Example 1

A sample (Example 1) is formed that contains 46.1 wt. % poly(hexamethylene dodecanediamide (PA612, melting point of 218° C., humidity absorption of 1.3% according to ISO 62, water absorption of 0.4% after being immersed in water for 24 hours), 30 wt. % hollow glass beads (crush strength of about 110 MP a, true density of about 0.46, average diameter of about 20 micrometers), 20 wt. % chopped glass fibers (average diameter of about 9-11 micrometers), 0.4 wt. % of an oligomeric hindered light amine stabilizer, 0.2 wt. % of sterically hindered phenolic antioxidant, 0.3 wt. % of a lubricant (calcium salt of long chain, saturated, linear montanic acids), and 3 wt. % of a carbon black/polyethylene black pigment masterbatch.

After being molded and dried, Comparative Example 1 and Example 1 were tested various mechanical properties. The results are set forth in the table below.

| | Comp. Ex. 1 | Comp.. Ex. 2 | Ex. 1 |
|---|---|---|---|
| Tensile Modulus (MPa) | 2,000 | 4,200 | 8,200 |
| Tensile Strength (MPa) | 30 | 88 | 129 |
| Tensile Strain at Break (%) | 36 | 4.7 | 2.28 |
| Notched Charpy Impact | 11 | 4.6 | 4 |
| Strength (kJ/m²) | | | |
| Flexural Modulus (MPa) | 1,900 | 3,600 | 8,100 |
| Flexural Strength (MPa) | 58 | 129 | 180 |
| Density (kg/m³) | 0.84 | 0.96 | 0.95 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polyamide composition comprising a polymer matrix that includes a long-chain aliphatic polyamide and from about 50 to about 200 parts by weight of an inorganic filler per 100 parts by weight of the polymer matrix that is distributed within the polymer matrix, wherein the inorganic filler includes inorganic fibers and hollow inorganic beads, wherein the polyamide composition exhibits a density of about 1,000 kg/m³ or less as determined in accordance with ISO 1183:2019 and a tensile modulus of about 4,000 MPa or more as determined in accordance with ISO 527:2019 at a temperature of about 23° C.

2. The polyamide composition of claim 1, wherein the polymer matrix constitutes from about 15 wt. % to about 70 wt. % of the polyamide composition.

3. The polyamide composition of claim 1, wherein long-chain aliphatic polyamides constitute the entire polymer matrix.

4. The polyamide composition of claim 1, wherein each monomeric constituent of the long-chain aliphatic polyamide has 6 or more carbon atoms.

5. The polyamide composition of claim 1, wherein the ratio of carbon to nitrogen atoms in the long-chain aliphatic polyamide is about 6 to about 15.

6. The polyamide composition of claim 1, wherein the long-chain aliphatic polyamide includes PA68, PA610, PA612, PA614, PA618, PA88, PA810, PA812, PA1010, PA1012, PA1014, PA1018, PA1210, PA1212, PA1214, PA1218, PA1313, PA1410, PA1412, PA 1414, PA1418, or a combination thereof.

7. The polyamide composition of claim 1, wherein the long-chain aliphatic polyamide includes PA612, PA610, or a combination thereof.

8. The polyamide composition of claim 1, wherein the long-chain aliphatic polyamide has a melting temperature of from about 180° C. to about 260° C., as determined using differential scanning calorimetry in accordance with 11357-3:2018.

9. The polyamide composition of claim 1, wherein the long-chain aliphatic polyamide exhibits a water absorption of about 1% or less after being immersed in water for 24 hours in accordance with ISO 62-1:2008.

10. The polyamide composition of claim 1, wherein the inorganic fibers constitute from 20 to about 80 parts by weight per 100 parts by weight of the polymer matrix and the hollow inorganic beads constitute from about 30 to about 90 parts by weight per 100 parts by weight of the polymer matrix.

11. The polyamide composition of claim 1, wherein the inorganic fibers have a softening point of about 850° C. or more as determined in accordance with ASTM C338-93 (2019).

12. The polyamide composition of claim 1, wherein the inorganic fibers include glass fibers.

13. The polyamide composition of claim 1, wherein the hollow inorganic beads include hollow glass beads.

14. The polyamide composition of claim 1, wherein the hollow inorganic beads have an average diameter of from about 1 to about 50 micrometers, average aspect ratio of about 0.8 or more, average true density of about 0.2 g/cm³ or more, and/or crush strength of about 10 MPa or more.

15. The polyamide composition of claim 1, wherein the hollow inorganic beads are treated with an amino-functional silane.

16. The polyamide composition of claim 1, wherein the composition further contains a stabilizer system, lubricant, or a combination thereof.

17. The polyamide composition of claim 16, wherein the stabilizer system includes a sterically hindered amine antioxidant, hindered amine light stabilizer, or a combination thereof.

18. The polyamide composition of claim 1, wherein the composition is generally free of blowing agents, elastomeric impact modifiers, and reactive polymeric compatibilizers.

19. The polyamide composition of claim 1, wherein the weight ratio of the inorganic fibers to the hollow inorganic beads is from about 1 to about 5.

20. The polyamide composition of claim 1, wherein the composition exhibits a flexural modulus of about 4,000 MPa or more as determined in accordance with ISO 178:2019 at a temperature of about 23° C.
